(19) United States
(12) Patent Application Publication
(10) Pub. No.: US 2024/0410409 A1
(43) Pub. Date: Dec. 12, 2024

(54) Nail row structure of nail gun

(71) Applicant: Chung Chin WEI, Taichung City (TW)

(72) Inventor: Chung Chin WEI, Taichung City (TW)

(21) Appl. No.: 18/731,112

(22) Filed: May 31, 2024

(30) Foreign Application Priority Data
Jun. 6, 2023 (TW) 112120942

(51) Int. Cl. F16B 15/08; B25C 1/00; F16B 15/00; F16B 15/02

(52) U.S. Cl. CPC F16B 15/08; F16B 15/0015; F16B 15/02; B25C 1/005

(57) ABSTRACT

A nail row structure of a nail gun contains: a body including multiple nails arranged on the body. Each of the multiple nails includes one or two feet and a hitting face which are one-piece formed on each nail, and an 90 degrees is defined between the hitting face and each of the two feet. The two feet have a head segment and are flatten, and the two feet have a flexible portion formed on a middle of the two feet away from the head segment, a tilted face c connected with the hitting face, and an expanding plane connected with the titled face c away from the hitting face.

### TECHNICAL FIELD

The present disclosure relates to a nail row structure of a nail gun which is capable of hitting the nails into the workpieces smoothly, linearly and securely.

### BACKGROUND

In the early days, iron hammers were used to hammer nails. With the advancement of the times, pneumatic nail guns are currently used to hit rows of nails. This method has many advantages, such as it can be operated with one hand and no effort is needed to hammer the nails. The automatic supply of nails during the beating action saves the trouble and inconvenience of finding and picking up nails. This has changed people's habit of using nails.

Pneumatic nail guns are currently mostly used in the decoration and decoration markets. Depending on the materials, there are different types of nails for fixing.

For example, most calcium silicates are currently fixed using screws, which are applied to fix the calcium silicates on the profiled steel. However, this fixing method is too slow, and the cost of screws is also high, so the man-hours and costs increase, although it is also operated by pneumatic tools, there are still some inconveniences in use, which increases the failure rate of nailing operations, such as skewing or falling off, resulting in low quality of work or processing obstacles, etc.

The present invention has arisen to mitigate and/or obviate the afore-described disadvantages.

### SUMMARY

A primary aspect of the present invention is to provide a nail row structure of a nail gun which is capable of hitting the nails into the workpieces smoothly, linearly and securely.

To obtain above-mentioned aspect, a universal connecting rod assembly provided by the present invention contains: nail row structure of a nail gun contains: a body including multiple nails arranged on the body. Each of the multiple nails includes one or two feet and a hitting face which are one-piece formed on each nail, and an 90 degrees is defined between the hitting face and each of the two feet. The two feet have a head segment and are flatten, and the two feet have a flexible portion formed on a middle of the two feet away from the head segment, a tilted face c connected with the hitting face, and an expanding plane connected with the titled face c away from the hitting face.

Other objects and features will be in part apparent and in part pointed out hereinafter.

### BRIEF DESCRIPTION OF THE DRAWINGS

FIG. 1 is a perspective view showing the assembly of a nail row structure of a nail gun according to a preferred embodiment of the present invention.

FIG. 2 is a perspective view showing the assembly of a part of the nail row structure of the nail gun according to the preferred embodiment of the present invention.

FIG. 3 is another perspective view showing the assembly of a part of the nail row structure of the nail gun according to the preferred embodiment of the present invention.

FIG. 4 is a perspective view showing the assembly of a part of a nail row structure of a nail gun according to another preferred embodiment of the present invention.

FIG. 5 is a perspective view showing the assembly of a part of a nail row structure of a nail gun according to another preferred embodiment of the present invention.

FIG. 6 is a perspective view showing the assembly of a part of a nail row structure of a nail gun according to another preferred embodiment of the present invention.

FIG. 7 is a perspective view showing the assembly of a part of a nail row structure of a nail gun according to another preferred embodiment of the present invention.

FIG. 8 is a perspective view showing the assembly of a part of a nail row structure of a nail gun according to another preferred embodiment of the present invention.

FIG. 9 is a schematic view showing the application of the nail row structure of the nail gun according to the preferred embodiment of the present invention.

FIG. 10 is a schematic view showing the application of the nail row structure of the nail gun according to the preferred embodiment of the present invention.

### DETAILED DESCRIPTION

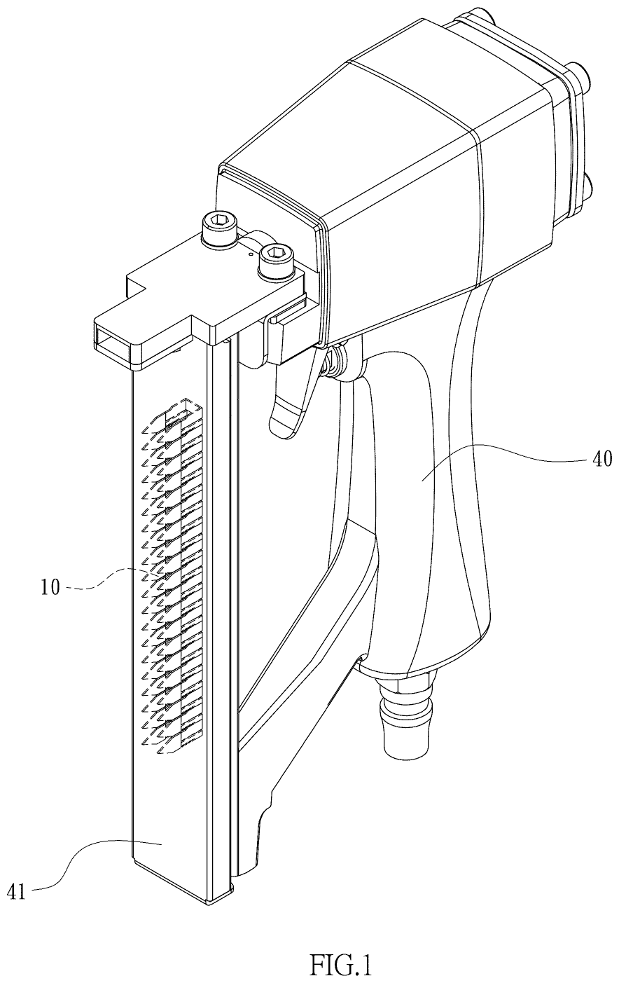

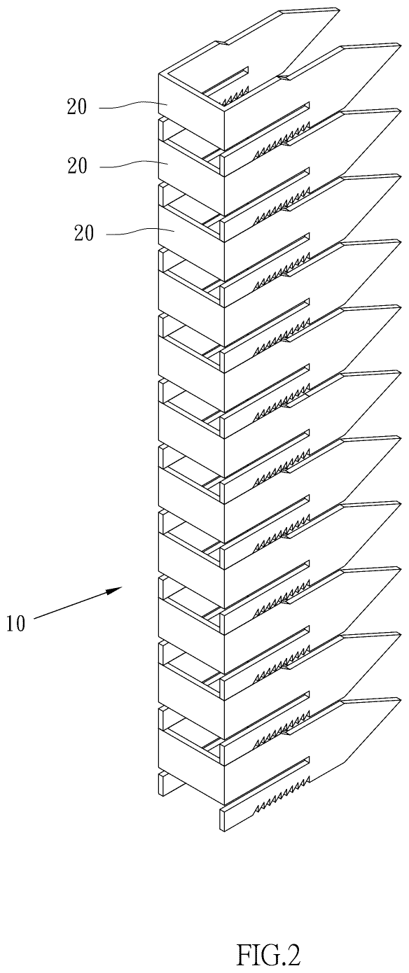

With reference to FIGS. 1-3 and 9-10, a nail row structure of a nail gun according to a preferred embodiment of the present invention comprises: a body 10 and multiple nails 20.

The body 10 includes multiple nails 20 arranged thereon.

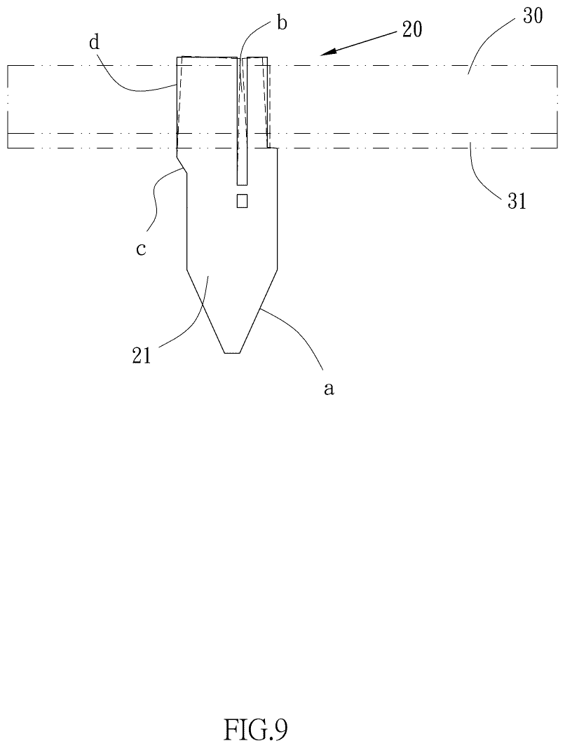

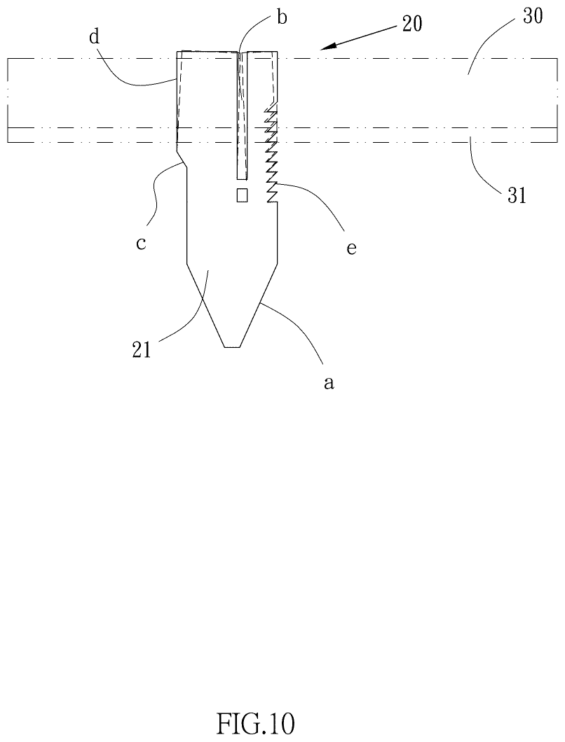

Each of the multiple nails 20 includes one or two feet 21, 22 and a hitting face 23 which are one-piece formed on each nail 20, wherein an 90 degrees is defined between the hitting face 23 and each of the two feet 21, 22, the two feet 21, 22 have a head segment a and are flatten, wherein the two feet 21, 22 have a flexible portion b formed on a middle of the two feet 21, 22 away from the head segment a, a tilted face c connected with the hitting face 23, an expanding plane d connected with the titled face c away from the hitting face 23, and multiple ratchets e opposite to the tilted face c, such that the two feet 21, 22 are hit into workpieces easily by using the flexible portion b and the tilted face c, and the expanding plane d abuts against the workpieces (such as a C-shaped steel 31 and a calcium silicate 30) securely. Preferably, the multiple ratchets e are pierced into the workpieces deeply to insert the two feet 21, 22 into the workpieces smoothly and linearly. Referring to FIG. 1, the body 10 is accommodated in a magazine 41 of the nail gun 10. As shown in FIGS. 9 and 10, the workpieces are the C-shaped steel 31 and the calcium silicate 30. Thus, the two feet 21, 22 are pierced into the workpieces easily, wherein the flexible portion b matches with the tilted face c and the expanding plane d so that the two feet 21, 22 are hit to pierce into the workpieces deeply and to abut against the C-shaped steel 31 and the calcium silicate 30, and the multiple ratchets e are engaged with the C-shaped steel 31 and the calcium silicate 30 matingly, thus hitting the nails into the workpieces smoothly, linearly and securely.

The heat a has a tip or a plane.

The flexible portion b is any one of a combination of a recess b1 and an opened slot b2, the opened slot b2, and a closed slot b3.

The expanding plane d also has multiple ratchets e.

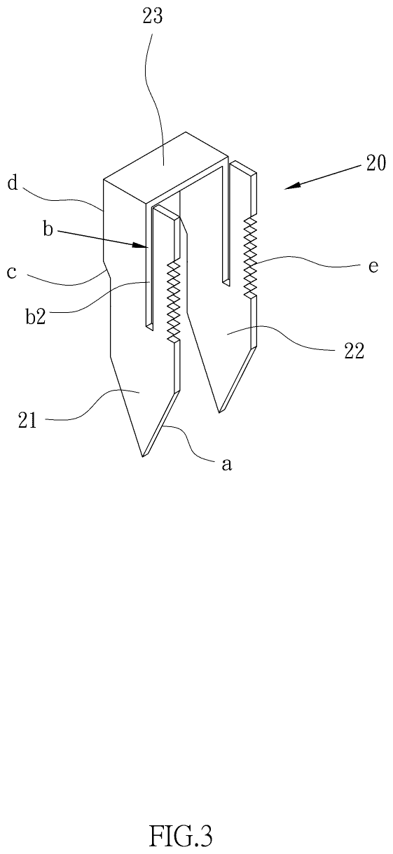

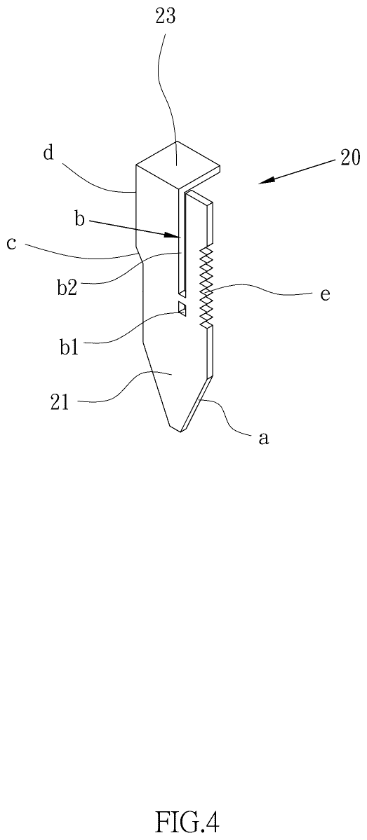

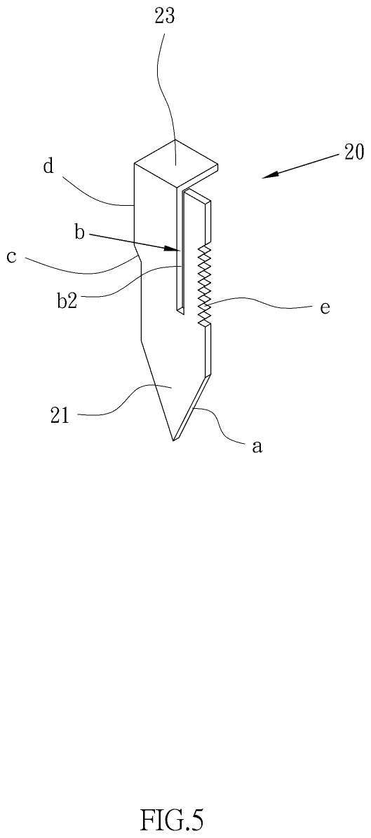

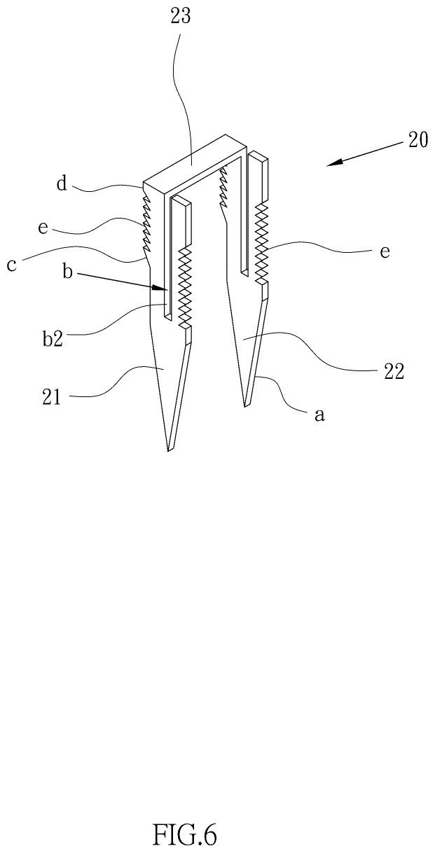

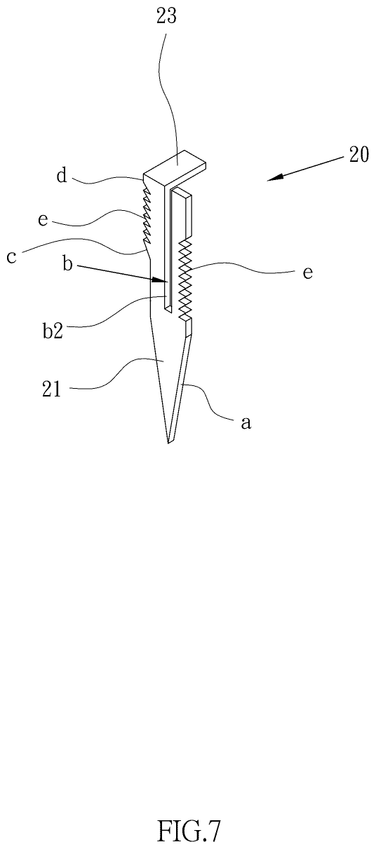

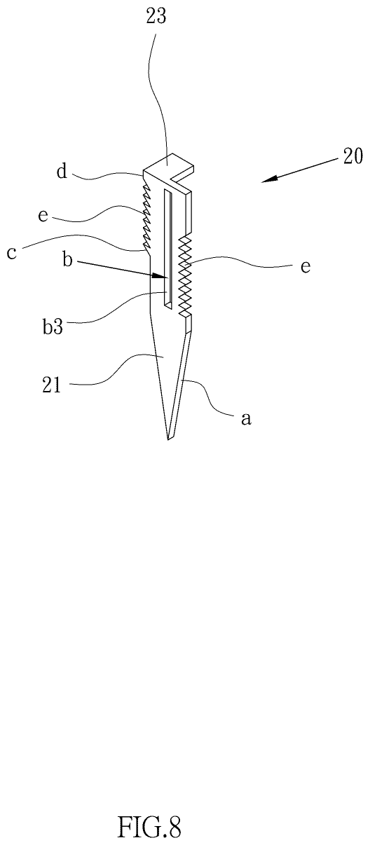

Referring to FIGS. 3-8, each of the multiple nails 20 includes one or two feet 21, 22 and a hitting face 23 which are one-piece formed on each nail 20, wherein an 90 degrees is defined between the hitting face 23 and each of the two feet 21, 22, the two feet 21, 22 have a head segment a and are flatten, wherein the two feet 21, 22 have a flexible portion b formed on a middle of the two feet 21, 22 away from the head segment a, a tilted face c connected with the hitting face 23, an expanding plane d connected with the titled face c away from the hitting face 23, and multiple ratchets e opposite to the tilted face c, wherein the flexible portion b is any one of a combination of a recess b1 and an opened slot b2, the opened slot b2, and a closed slot b3. The heat a has a tip or a plane. The expanding plane d also has the multiple ratchets e.

When introducing elements of the present invention or the preferred embodiments thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A nail row structure of a nail gun comprising:
a body including multiple nails arranged on the body;
wherein each of the multiple nails includes one or two feet and a hitting face which are one-piece formed on each nail, and an 90 degrees is defined between the hitting face and each of the two feet, the two feet have a head segment and are flatten, wherein the two feet have a flexible portion formed on a middle of the two feet away from the head segment, a tilted face c connected with the hitting face, and an expanding plane connected with the titled face c away from the hitting face.

2. The nail row structure as claimed in claim 1, wherein the two feet have multiple ratchets e opposite to the tilted face.

3. The nail row structure as claimed in claim 1, wherein he flexible portion is any one of a combination of a recess and an opened slot, the opened slot, and a closed slot.

4. The nail row structure as claimed in claim 1, wherein the expanding plane also has multiple ratchets.
